(19) United States
(12) Patent Application Publication
(10) Pub. No.: US 2006/0175767 A1
(43) Pub. Date: Aug. 10, 2006

(54) Sealing arrangement for use in evacuating a glass chamber

(76) Inventors: Richard Edward Collins, New South Wales (AU); Kwok Leuns Ng, New South Wales (AU)

Correspondence Address: LADAS & PARRY LLP, 224 SOUTH MICHIGAN AVENUE, SUITE 1600, CHICAGO, IL, 60604, US

(21) Appl. No.: 10/546,794

(22) PCT Filed: Feb. 25, 2004
(86) PCT No.: PCT/AU04/00238

§ 371 Date: Jan. 10, 2006

(30) Foreign Application Priority Data
Feb. 26, 2003 (AU) 2003900862

(51) Int. Cl. F16J 15/02

(52) U.S. Cl. 277/644; 277/653; 141/65

(57) ABSTRACT

A gasket (10) is provided for an evacuation head assembly (20) to evacuate a chamber (104) defined by two glass sheets (101, 102). The gasket (10) may be made from a metal foil such as aluminium and has opposite sealing surfaces (14, 15, 19) that are profiled with a series of fine grooves (17) and wherein the variation in thickness between the sealing surfaces is less than 1 μm.

### FIELD OF THE INVENTION

This invention relates to the evacuation of a chamber that is defined (i.e. enclosed) by a glass wall that includes a port through which evacuation is effected. The invention has been developed in the context of evacuated glass panels, such as vacuum glazing and plasma display panels, and the invention is herein described in that context. However, it will be understood that the invention does have broader application, for example including flat panel-formed display devices.

### BACKGROUND OF THE INVENTION

In one form of vacuum glazing, two plane spaced-apart sheets of glass are positioned in face-to-face confronting relationship and are hermetically sealed around their edges with a low melting point glass that commonly is referred to as solder glass. The space (i.e. chamber) between these sheets is evacuated and the face-to-face separation of these sheets is maintained by a network of small support pillars. In typical situations the glazing may comprise of glass sheets that have a surface area in the order of 0.02 to 4.00 sq m, sheet thicknesses in the order of 2.0 mm to 5 mm and face-to-face face spacing in the order of 0.1 mm to 0.2 mm.

The manufacture of flat evacuated glass panels normally consists of two steps, both of which involve heating the panel to a high temperature. In the first step, the hermetic seal is made around the periphery of the two glass sheets using the solder glass. In the process, solder glass powder is deposited as a liquid slurry around the periphery of the glass sheets, and the entire assembly is heated to a high temperature, typically in excess of 460° C. At this temperature, the solder glass melts, forming an impervious mass, and wets the glass sheets. A strong, leak free seal is therefore formed around the edges of the glass sheets when the solder glass solidifies as the assembly is cooled toward room temperature.

In the second production step, the chamber of the panel is evacuated. This is normally done by using a vacuum system to remove the air within the panel through a small aperture, or hole, in one of the glass sheets. During this evacuation process, the assembly is usually placed in an oven, and heated to high temperature in order to remove residual gases from the surfaces within the evacuated space.

The connection of the chamber of the panel to the evacuation system can be made in several ways. In one method, a long glass tube is sealed around the aperture in one of the glass panels, so that the interior of the tube is connected to the internal volume of the panel. This seal is normally made with solder glass during the edge seal process. After the glass sheets have cooled to room temperature at the completion of the edge seal process, the tube is connected to the vacuum system using an o-ring seal coupling. This connection is usually made at a point outside the oven that is used to heat the panel during the evacuation process, so that the o-ring remains cool during the heating operation.

In another evacuation method, the aperture may simply be a hole in one of the glass sheets. Alternatively, the aperture may consist of a hole through one of the glass sheets to which a short glass tube is sealed with solder glass. In the evacuation process of the flat glass panels using these designs, a seal is made directly to the surface of the glass sheet, around the aperture. In one implementation of this method, an evacuation cup (or head) is placed over the aperture, and is sealed to the surface of that sheet with an o-ring. In this case, the temperature of the glass sheets during the evacuation process is limited to about 220° C., because the o-ring materials decompose at higher temperatures. At the completion of the bake out process, the aperture is closed either by sealing a cap over the hole in the glass sheet, or by melting the end of the glass tube.

It has been recognised that, if the edge seal and evacuation processes can be performed in a single heating step, there are significant advantages such as reduced production time and cost. This is not possible if an o-ring is used to seal the evacuation cup to the glass sheet, however because the material of the o-ring will not survive the high temperature of the edge seal process.

A method has been developed for overcoming this difficulty and this method is described in the applicants' earlier application PCT/AU99/00964. The method uses an evacuation head that can withstand the high temperatures of the process used to form the solder glass edge seal. The evacuating head has two concentric sealing surfaces that are forced against the glass sheet around the evacuation aperture by atmospheric pressure when the cup is evacuated. The seals formed by the contact between the surfaces and the glass sheet are not completely leak free. The sealing surfaces define two concentric chambers between the cup and the glass sheet that are differentially pumped, using separate vacuum systems. The outer annular chamber is normally evacuated using a rotary pump, and the pressure in this chamber typically is about 1 Torr. The inner chamber is pumped using a high vacuum system, that utilises either a diffusion pump or a turbomolecular pump, and the pressure in this chamber is typically 10⁻³ Torr, and can be as low as 10⁻⁴ Torr. The pressures within the two chambers of the evacuating head depend on the pumping speed of the lines that evacuate them, and on the leak rates for air through the small gaps between the sealing surfaces of the head and the surface of the glass sheet. These leak rates are determined by many factors, including the cleanliness of the two surfaces, and their planarity.

The achievement of a vacuum of 10⁻³ Torr within the central region of an evacuating head is adequate for many applications, including some designs of vacuum glazing that are not very highly insulating. For many applications, however, a higher level of vacuum is desirable. Very highly insulating designs of vacuum glazing require that the pressure within the internal volume should be about 10⁻⁴ Torr, or less. In addition, the processing requirements of plasma display panels require that the pressure within the internal volume of the panel during the production should be even lower, between 10⁻⁵ Torr and 10⁻⁶ Torr. In International Patent Application PCT/AU99/00964, a method is described for achieving such low pressures. This method utilises three or more pumping stages in the evacuating head. Whilst such multiple pumping techniques work very satisfactorily, they do require a more complex and expensive vacuum system.

Another problem of the evacuating head is that the direct contact between the metal sealing surfaces of the cup and the surface of the glass sheet can produce marks on the glass surface. Although these marks do not significantly weaken the glass, they are undesirable because they are cosmetically unattractive in the completed evacuated panel. In order to prevent the occurrence of these marks, a relatively soft metal gasket can be used between the evacuating head and the glass surface. This gasket must be made from a material that does not melt at the maximum temperatures that are reached during the fabrication of the glass panel, and that has a very low vapour pressure at these high temperatures. Aluminium, with a melting point of approximately 660° C., is a very suitable material for this gasket.

In the past, the gasket has been fabricated from commercial grade rolled aluminium foil, which is typically approximately 50 μm thick. The gasket is larger in dimension than the outer diameter of the evacuating head. It has a central hole that is large enough to accommodate the region around the pump out aperture of the glass panel. It also has one, or more holes in the region that is located between the sealing surfaces of the evacuating head in order that air is removed from the space between the gasket and the surface of the glass sheet when the angular region of the cup is evacuated.

However, previously, the use of the gasket has not allowed a level of vacuum to be achieved that is required in highly insulating designs of vacuum glazing and for plasma display panels.

### SUMMARY OF THE INVENTION

The present invention is directed to an improved sealing arrangement for evacuating a chamber, and in at least a preferred form, in a high temperature process.

In a first aspect the invention provides a gasket for use in providing an air seal between a glass wall and an evacuation head, the gasket having opposite faces and comprising a first sealing surface on one face for engaging a corresponding sealing surface on the evacuation head, and a second sealing surface on the opposite face for engaging the glass wall, wherein the variation in the thickness between the sealing surfaces around the gasket is less than 1 μm.

In one embodiment, the gasket is heat resistant and able to withstand temperatures in excess of 400° C. and more preferably in excess of 460° C. In one form, the gasket material also has a very low vapour pressure at these high temperatures. In that application, preferably the gasket is formed from a metal or metallic alloy. In a particularly preferred form, the gasket is formed from aluminium having a thickness of between 20 μm and 80 μm.

In one embodiment, the sealing surface on at least one face of the gasket is profiled so as to be more compliant to deform on applying a compressive force to that sealing face.

In a particular embodiment, the at least one gasket face is profiled to include an arrangement of at least one raised ridge. In use, the raised ridge(s) form the sealing surface of that face of the gasket and in one form extend continuously around the gasket so as to provide a high quality air seal. In one form, the raised ridge may be of spiral form, whilst in another embodiment, may be in the form of at least one, but preferably more, ring(s).

A gasket of the above form is ideally suited for use in the manufacture of evacuated glass panels where the panel and evacuation head are subjected to high temperatures. Such an application is that used in the single heating step manufacturing process described above. A gasket according to an embodiment of the invention exhibits more effective sealing under relatively low compressive force than traditional gaskets formed from aluminium foil, whilst still being able to accommodate a high temperature environment.

When a metal gasket is used to make a seal to a glass surface, the force that compresses the gasket must be kept sufficiently low that it will not cause fracture of the glass. In the practical application of using an evacuation head to evacuate a glass panel, it is undesirable and inconvenient, to utilise an external clamping system to apply a compressive force on the gasket. This compressive force should be therefore ideally limited to that caused by atmospheric pressure acting on the outer surface of the evacuation head. For a typical head that is 70 mm in diameter, this force is equivalent to a weight of approximately 40 kg. Including profiling on the gasket allows the gasket to deform so as to provide a better seal. This occurs as the profiling causes stresses in the parts of the gasket material that contact the evacuation head or glass wall to be larger than would occur in a flat gasket. Secondly, gasket material can flow sideways into the grooves on the surface of the gasket. In addition, by providing a gasket where the point-to-point variation in thickness of the sealing surfaces is less than 1 μm significantly improves the sealing arrangement as it substantially reduces the amount of gap between the sealing surfaces.

In a second aspect, the invention provides a gasket for use in providing an air seal between a glass wall and an evacuation head, the gasket having opposite faces and comprising a first sealing surface on one face for engaging a corresponding sealing surface on the evacuation head, and a second sealing surface on the opposite face for engaging the glass wall, wherein the sealing surface on at least one face of the gasket is profiled so as to be more compliant to deform on applying a compressive force to that sealing face.

In one form, only one side of the gasket is profiled. This gasket may be used with the smooth side in contact with the evacuation head, and the profiled side contacting the glass sheet. In this case, the increased levels of stress on both sides permit the gasket to deform readily.

In another form, both sides of the gasket are profiled.

In the arrangement where the gasket is profiled to include raised regions and at least one groove, the material from the raised regions may not completely fill the grooved regions. If a spiral groove is used, narrow leakage paths therefore exist on both sides of the gasket, across the sealing surfaces of the evacuation head, through these incompletely filled spiral grooves. A simple calculation shows that a negligible quantity of air leaks along these grooves during production of a glass panel. The existence of this spiral leakage channel therefore does not significantly degrade the quality of the vacuum seals.

In one form, the gasket is pressed to limit the variation in thickness and/or to profile the gasket surface(s). In another form, photolithographic techniques could also be used to produce the grooved structure directly onto the surface of the gasket. If this method were to be used, preferably, the gasket material itself is sufficiently uniform in thickness that the deformation caused during its use with the evacuation head is sufficient to achieve a vacuum seal of adequate quality. The point-to-point variations in thickness of conventionally rolled aluminium foil are much larger than desirable when it is used as a gasket to seal the evacuation head to a glass sheet. It is possible that specialized rolling techniques may reduce the point-to-point variations in thickness compared with conventionally rolled aluminium foil, and that foil produced in this way would be suitable if the grooves were to be produced photolithographically.

In a further aspect, the present invention provides a method of evacuating a chamber that is enclosed at least in part by glass walls that includes an evacuation port. The method comprises the steps of:

covering a port and a portion of the glass wall that surrounds the port with an evacuation head having a first cavity that communicates with the port;

providing a gasket between the evacuation head and the glass wall to provide an air seal between the glass wall and the head;

inducing a compressive force on the gasket so as to cause it to deform sufficiently to improve the seal between the wall and the head; and

evacuating the glass chamber by way of the first cavity.

In one form, the method according to this aspect of the invention further comprises the step of subjecting the glass wall to a temperature of greater than 450° C. whilst maintaining the air seal between the glass wall and the evacuation head.

In one form, the compressive force is applied to the gasket as a result of evacuating a cavity in the evacuation head. In one form this may be by evacuating the first cavity (which in turn evacuates the chamber). In another form it may be through evacuating a second cavity in the evacuation head, or the compressive force may be applied by evacuating both the first and second cavities.

In a particular form, the gasket is in any form as described above in the earlier aspect of the invention. More particularly the gasket may be formed from an aluminium foil that is preformed so that it is more compliant to deformation than standard flat aluminium foil. In one form, the foil is caused to deform under the compressive force applied as a result of evacuating a cavity in the evacuation head. Under that force, the thickness of the gasket measured between the sealing surfaces with the glass wall and the evacuation head may reduce by more than 1 μm.

In yet a further aspect, the present invention provides an evacuation head assembly for use in any of the methods described above. In this aspect, the evacuation head assembly comprises an evacuation head and a gasket made in accordance with any of the forms described above.

In yet a further aspect, the invention provides an evacuation head that has a coefficient of thermal expansion that is close to that of the glass wall.

In the past, for most vacuum equipment, the evacuation head used in evacuating glass panels is made from austenitic (or 300 Series) stainless steel, such as type 304. This material is readily machined and welded, and retains strength and corrosion resistance at high temperatures, as are required in the vacuum glazing manufacturing process. The coefficient of thermal expansion of this material over the relevant temperature range is approximately 18×10⁻⁶° C.⁻¹. For soda lime glass (which is typically used to form the glass wall), the coefficient of thermal expansion is much lower, about 8×10⁻⁶° C.⁻¹.

By providing an evacuation head where the coefficient of thermal expansion is closer to that of the glass panel, it has been found that there is substantially less degradation in the conductance of the vacuum seals between the evacuation head and the glass sheet when this system cools toward room temperature. The materials that are suitable for this aspect of the invention include martinsitic (or 400 Series) stainless steel. These types of stainless steel have a substantially smaller coefficient of thermal expansion than the austenitic types. For example, the coefficient of thermal expansion of Type 410 stainless steel over the relevant temperature range is approximately 11×10⁻⁶° C.⁻¹.

Providing an evacuation head that has a coefficient of thermal expansion that is close to that of the glass wall provides significant benefits where the evacuation head assembly incorporates a gasket made in accordance with any of the forms described above. Measurements have shown that, at high temperatures, a relatively weak bond is formed between the aluminium foil and the glass, and that the aluminium gasket does not move relative to the glass during cooling of the panel. The quality of the vacuum seal between these components is therefore maintained as the system cools to room temperature. However, if the coefficient of thermal expansion of the evacuation head is not close to that of the glass wall, as the system cools, the evacuation head contracts more than the glass sheet. This causes the sealing surfaces of the cup to move relative to the corresponding regions of the glass. Because the aluminium gasket is bonded to the glass sheet, the cup therefore slides inwards relative to the aluminium gasket. The very good vacuum seal between the evacuation head and the gasket that is formed due to inelastic deformation of the profiled surface of the gasket at high temperatures is therefore degraded as the system cools towards room temperature.

Making the coefficient of thermal expansion of the evacuation head close to that of the glass wall ameliorates this problem. As such substantially less degradation occurs in the conductances of the vacuum seals between the evacuation head and the glass sheet when the system cools toward room temperature.

In yet a further aspect, the invention is directed to a method of processing a gasket to reduce the variation in thickness of the sealing surfaces of the gasket, and to profile at least one surface of the gasket so as to make it more compliant to deformation under a compressive force. In one embodiment, this is achieved in a single step pressing process. In yet a further aspect, the invention relates to a pressing tool for use in the above process.

### BRIEF DESCRIPTION OF THE DRAWINGS

It is convenient to hereinafter describe embodiments of the invention with reference to the accompanying drawings. The particularity of the drawings and the related description is to be understood as not superseding the preceding broad description of the drawings.

In the drawings:

FIG. 1 is a schematic cut-away perspective view of vacuum glazing;

FIG. 2 show sequential steps (a) to (e) in the fabrication of glazing using a single step manufacturing process incorporating an evacuating head;

FIG. 3 is a plan view of a gasket used in the process of FIG. 2;

FIG. 4 is a detailed cross-sectional view of part of the gasket of FIG. 3;

FIG. 5 is a detailed cross-sectional view to an enlarged scale of part of the gasket when utilised in the manufacturing process of FIG. 2;

FIG. 6 is a schematic view of a press tool for the manufacture of the gasket of FIG. 3;

FIG. 7 is a schematic view of the tooling apparatus for machining the bearing surfaces of the press tool of FIG. 6;

FIG. 8 is a detailed view to an enlarged scale of the bearing surface of the press tool of FIG. 6;

FIG. 9 is a schematic representation of glazing located within a bake-out chamber and connected to external vacuum pumps by way of the evacuating head; and

FIGS. 10 to 13 show plots of measurements obtained in implementing the procedure of FIG. 2, and variations thereof.

### DETAILED DESCRIPTION OF THE INVENTION

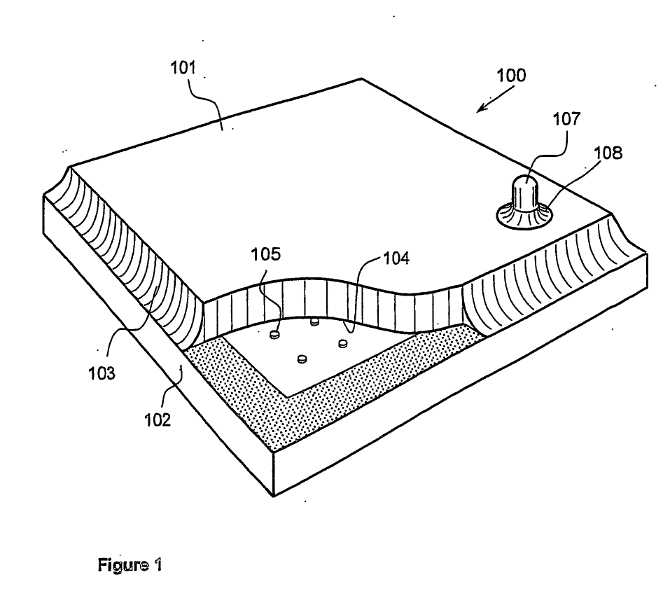

FIG. 1 illustrates a flat evacuated glass panel 100 which comprises two plane glass sheets 101, 102 that are maintained in spaced-apart face-to-face confronting relationship. The glass sheets are normally composed of soda-lime glass and are interconnected along their edges by a bead 103 of edge-sealing solder glass.

A chamber 104 is defined by the two glass sheets 101, 102 and these sheets are maintained in spaced relationship by a network or array of support pillars 105. The chamber 104 is evacuated to a level below 10⁻³ Torr, this providing for gaseous heat conduction through the sheets that is negligible relative to other heat flow mechanisms.

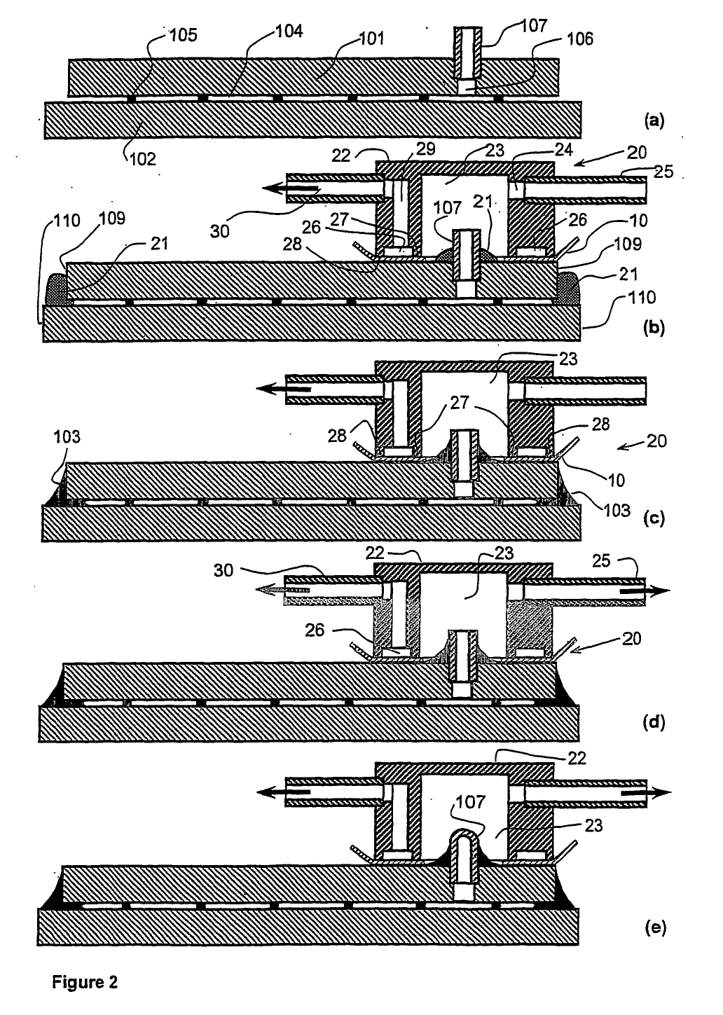

The glass sheet 101 is formed with an aperture 106 (see FIG. 2), and a glass pump-out tube 107 is positioned to locate within and project outwardly from the aperture 106. The pump-out tube is sealed to the glass sheet by a bead 108 of solder glass. The pump-out tube is sealed following evacuation of the panel as illustrated in FIG. 1.

The manufacture of the flat evacuated glass panels 100 requires two main operations, the first being to provide the edge seal around the glass panels 101, 102, the second being to evacuate the chamber 104. Typically both these operations involve heating the panel to a high temperature.

Whilst traditionally these two operations were conducted in separate steps, they, can be performed in a single heating step as described in detail in the applicant's previous International Application PCT/AU99/00964. This single stage process is illustrated with reference to FIG. 2 wherein an evacuating head 20 is utilised. Initially, the two glass sheets 101, 102 of the panel 100 are assembled as shown in FIG. 2(a). Solder glass 21, as a powder in liquid slurry, is then deposited around the external edges 109, 110 of the glass sheets and around the pump-out tube 107 as shown in FIG. 2(b).

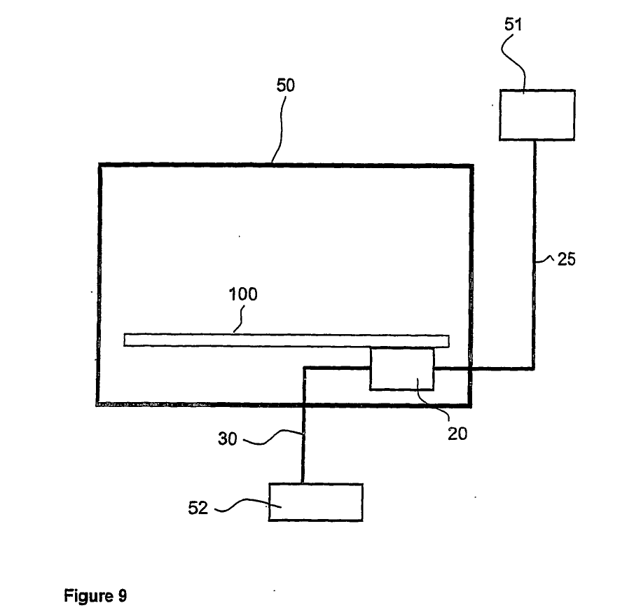

The evacuating head 20 is positioned on the surface of the sheet 101 over the pump-out tube 107. The evacuating head 20 comprises a metal body 22, which incorporates or is formed with a central first cavity 23. The first cavity 23 is shaped in dimension to receive the pump-out tube 107 and to provide for unrestricted movement of gas during evacuation and out-gassing of the chamber 104. The first cavity 23 is connected by way of a port 24 and a conduit 25 to a vacuum pump 51 that is located outside of a baling chamber 50 as shown schematically in FIG. 9.

A second annular cavity 26 also is provided within the body 22 of the evacuating head 20. The second cavity 26 is positioned to surround the first cavity 23 and is arranged in use to be closed by the surface of the glass sheet 101 that surrounds the pump-out tube 107. A first annular land 27 is located between the first and second cavities 23, 26, and a second annular land 28 surrounds the annular second cavity 26.

A gasket 10 is disposed between the evacuating head and the glass sheet 101 as is discussed in detail below, and which designed to provide a good vacuum seal between the evacuating head 20 and the glass sheet 101.

The annular lands 27, 28 of cavity 26 are connected by way of a port 29 and a conduit 30 to a further vacuum pump 52 as indicated in FIG. 9.

The evacuating head 20 will typically have an outside diameter of 50 mm to 100 mm and the first central cavity 23 will typically have a diameter in the order of 10 mm to 20 mm. The lands 27, 28 will each have a radial width in the order of 1 mm but may be in the range of 0.10 mm to 10 mm.

Following the connection of the evacuating head 20 to the panel 100, the complete assembly is heated to around 460° C. within the baking chamber. During this process, the solder glass melts to form the seals 103 around the edges of the glazing 101, 102 and around the pump-out tube 107. At the same time, the annular cavity 26 between the two annular lands, 27 and 28, is evacuated by the pump 52. The pump 52 is typically a rotary pump and the pressure in this cavity 26 typically reaches values of around 1 Torr.

The glazing and the evacuating head are then cooled (to a temperature of around 380° C.) at which the solder glass solidifies, and the evacuation of the chamber 104 between the two glass sheets 101, 102 is then commenced by connecting the high vacuum system 51 to the central cavity 23 of the evacuating head 20. This high vacuum system 51 utilises either a diffusion pump or a turbomolecular pump and the pressure in this chamber is typically 10⁻³ Torr or less.

The achievement of vacuum of 10⁻³ Torr within the central region of the evacuating head is adequate for many applications, including some designs of vacuum glazing that are not very highly insulating. However, a higher level of vacuum is desirable, for example, a small but significant amount of heat that flows via thermal conduction through a vacuum of 10⁻³ Torr results in a measurable reduction of the thermal insulating performance of vacuum glazing. Very highly insulating designs of vacuum glazing therefore require that the pressure within the internal volume should be about 10⁻⁴ Torr or less. In addition, the processing requirements of plasma display panels require that the pressure in the internal volume of the panel during this production should be even lower, between 10⁻⁵ Torr and 10⁻⁶ Torr. By incorporating the gasket 10 between the evacuating head 20 and the glass sheet 101, enables these high levels of vacuums to be achieved because of the effectiveness of the seal provided by the gasket.

Evacuation of the cavity 23 is maintained as the glazing 100 and the evacuating head 20 are cooled. The specific temperature/time schedule that is used during this cooling period all depend on the time necessary to achieve adequate out-gassing of the internal surfaces for glazing and therefore may vary depending on the construction of the glazing 100.

When the out-gassing and the evacuation have been completed, the pump-out tube 107 is closed, completing the construction of the panel. In the form shown in FIG. 2e, this is by melting and fusing the end of the pump-out tube 107.

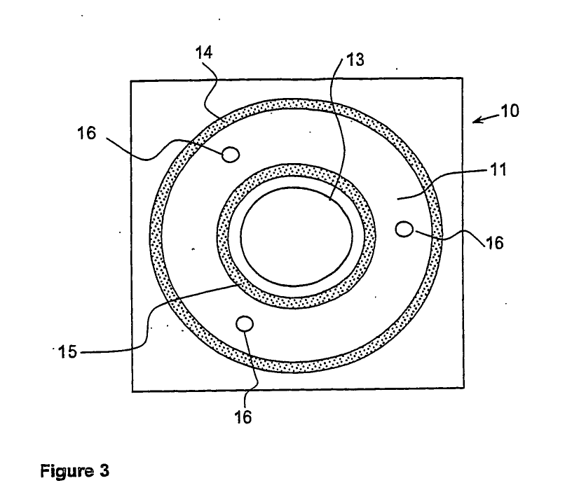

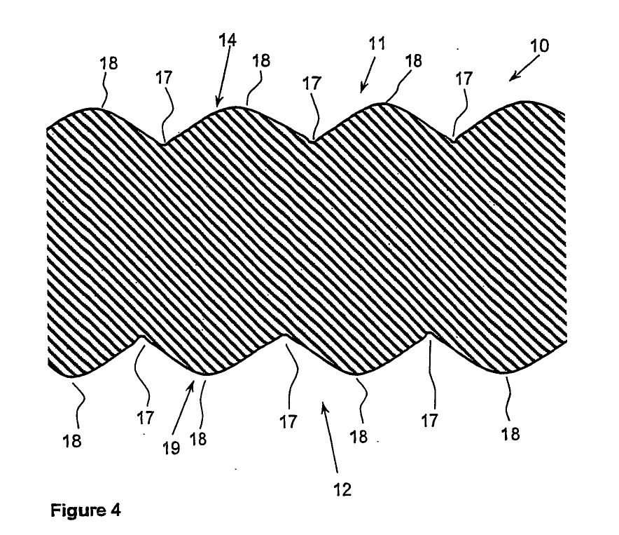

FIGS. 3 and 4 illustrate the gasket 10 used in the evacuation process described above.

The gasket 10 is typically made from a commercial grade rolled aluminium foil, 50 μm thick. The gasket needs to be made from a material that does not melt at the maximum temperatures that are reached during the fabrication of the glass panel, and that has a very low vapour pressure at these high temperatures. Also it is preferable that the gasket is made from a relatively soft metal to inhibit marking of the glass by the evacuation head. Whilst aluminium is a very suitable material it will appreciated by those skilled in the art that other materials such as other suitable metals or metallic alloys may be used.

The gasket 10 is larger in dimension than the outer diameter of the evacuating head 20. It has opposite major faces 11 and 12 and incorporates a central hole 13 that is large enough to accommodate the region around the pump-out tube 107 of the glass sheet 101. The gasket 10 also includes on one face 11, or on both faces 11, 12 annular sealing surfaces 14, 15 that are designed to register with the annular lands 27, 28 of the evacuating head 20.

The gasket 10 also includes one, or more holes 16 between the sealing surfaces 14, 15. These holes enable air to be removed from the space between the gasket 10 and the surface of the glass sheet 101 when the annular region of the cup is evacuated.

As best illustrated in the FIG. 4, the sealing surfaces 14, 15 are specially profiled with a series of fine, concentric or nearly concentric grooves 17 separated by raised ridges 18. Similar annular profiled surfaces 19 are provided on the other face 12 which are in engagement with glass sheet 101 and which are disposed directly opposite profiled surfaces 14, 15 on the upper face 11 of the gasket 10. This profile in the sealing surfaces (14, 15, 19) is to make the gasket more compliant so that it will deform more readily on compression of the gasket between the glass sheet 101 and the evacuation head 20.

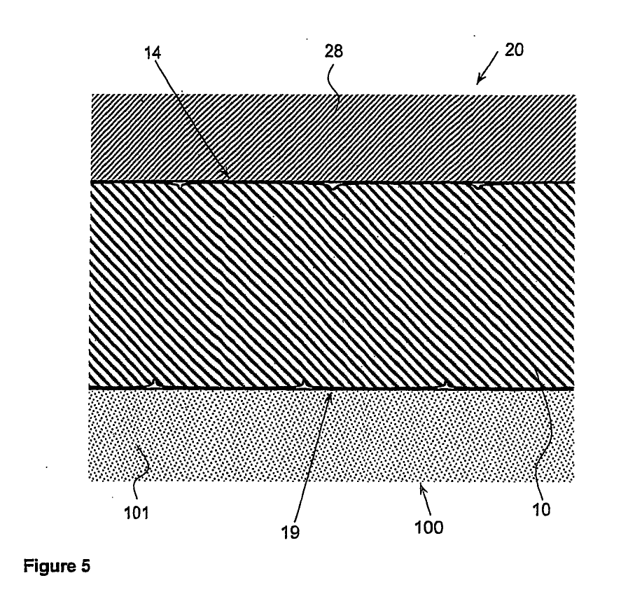

As the evacuation head 20 and the gasket 10 is heated to high temperatures during the process to form the edge seal of the glass panel 100, the yield strength of the aluminium gasket decreases, and the engaging surfaces of the evacuation head 20 (i.e. lands 27, 28) progressively deform the material of the gasket under the forces due to atmospheric pressure. The profiled sealing surfaces of the gasket enable a significantly larger amount of deformation to occur than would occur if the surfaces were flat. This increased deformation occurs for two reasons. Firstly, the gasket 10 is in contact with the sealing surfaces of the evacuation head and the glass sheet only over the raised ridges 18 which represent only a small fraction of the nominal area of the sealing surfaces. As a consequence, the stresses in the parts of the gasket material that contact these surfaces are larger than would occur in a flat surface. Secondly, material from the ridges 18 of the gasket which contact the sealing surfaces of the evacuation head and glass panel 101 can flow sideways into the grooves 17 on the sealing surfaces of the gasket. The given amount of compression of the process gasket therefore requires significantly less movement of the material of the gasket than it would for gasket having flat sealing surfaces. FIG. 5 shows schematically how the shape of the metal gasket could normally change after it is compressed between the evacuation head 20 and the glass panel 101. The presence of the grooves 17 therefore effectively increases the compliance of the gasket, permitting average overall deformations of between 1 μm and 2 μm at the sealing surfaces on each face of the gasket.

To further enhance the effectiveness of the gasket 10 in providing a seal between the evacuation head 20 and the glass sheet 101, the gasket is provided so that the point-to-point variations in thickness between opposite ridge regions are within a tight tolerance of preferably less than 1 μm and more preferably less than 0.6 μm. Maintaining this tight tolerance improves the seal as any departures from planarity of the sealing surfaces of the evacuation head gasket and the glass may affect the quality of the seal, particularly if the amount of deformation of the gasket cannot compensate for the departures in planarity.

It is possible to machine the sealing surfaces of the evacuation head so that the point-to-point departures from planarity are much less than plus or minus 0.1 μM. Even smaller departures from planarity occur in a piece of float glass over the diameter of the typical evacuation head. The point-to-point variations in the average thickness of conventionally rolled aluminium foil are however, typically as large as ±2% of the thickness of the foil, or ±1 μm, for 50 μm thick foil. However, measurements have shown that local variations in the thickness as large as ±2 μm can occur at points that are a few millimetres apart in such foil. These variations arise because of the manner in which the foil is made during the rolling process.

Accordingly, to provide a good vacuum seal using an aluminium gasket it is therefore necessary to eliminate the gaps that are caused by the departures from planarity of the aluminium foil under the relatively small force on the gasket due to the action of the atmospheric pressure 6n the evacuation head.

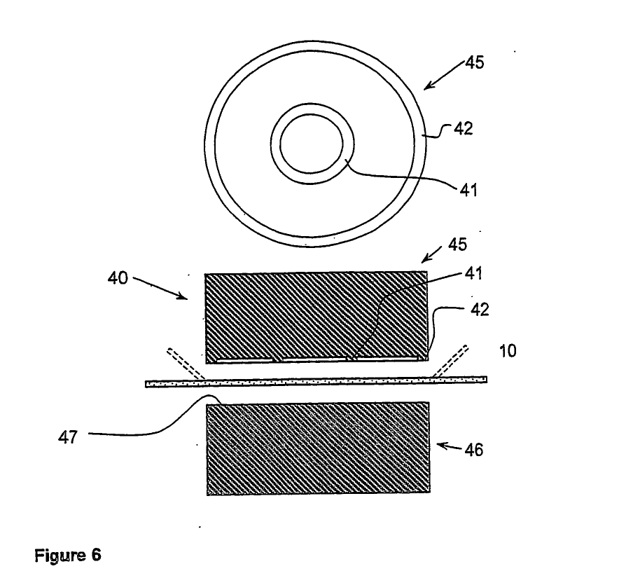

To provide both the profiling on the sealing surfaces 14, 15, 19 of the gasket and the variation in point-to-point thickness of those surfaces, the gasket 10 is processed prior to being introduced into the evacuation assembly. This prior processing is done through a single pressing operation as best illustrated in FIG. 6.

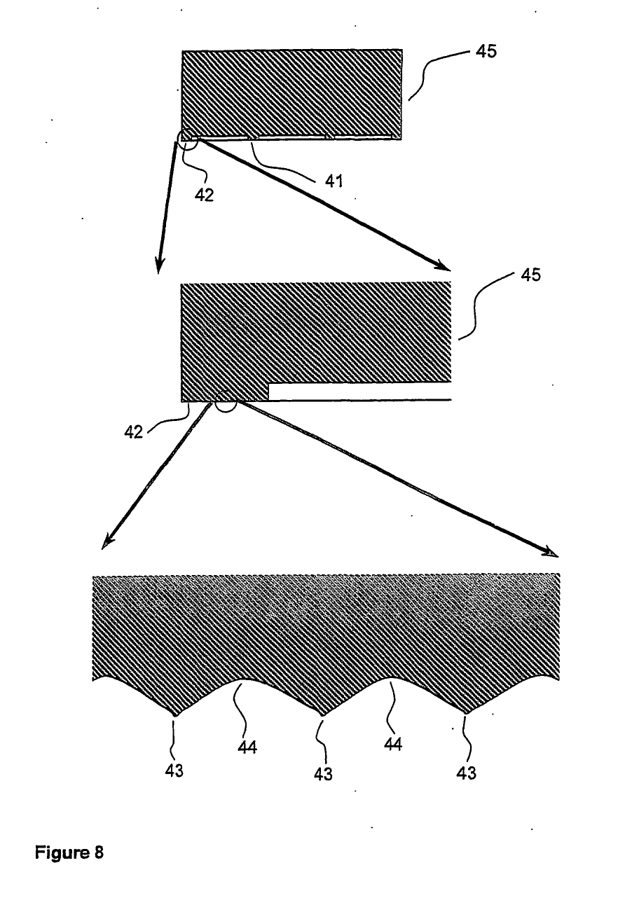

Specifically as shown in FIG. 6, the processing of the gasket involves compressing regions of the gasket by two hard metal surfaces 41, 42 on one part of a press tool 40 onto a flat surface 47 on the other part of the press tool 46. The press tool is made so that the surfaces 41, 42 on one side, and 47 on the other side that bear on the gasket during the compression operation are nominally very flat. Both of these bearing surfaces also have a fine structure consisting of a series of concentric, or nearly concentric raised ridges 43, separated by slightly recessed regions 44 as best illustrated in FIG. 8. The individual ridges 43 on the bearing surfaces 41, 42, 47 of the metal press tool 40 are typically between 1 μm and 5 μm higher than the groove regions 44 of that surface. During the pressing operation, the gasket 10 is irreversibly deformed, so that the profile of the surfaces 41, 42, 47 of the press tool 10 are transferred to the surfaces 14, 15, 19 of the gasket to thereby form the profiled sealing surfaces of the gasket. The hard surfaces of the press tool therefore impart a structure on the surface of the gasket that reflects the shape of the surfaces of the press tool. In addition, because the bearing surfaces of the press tool are very flat, the compression of the gasket reduces point-to-point variations in the thickness of the gasket.

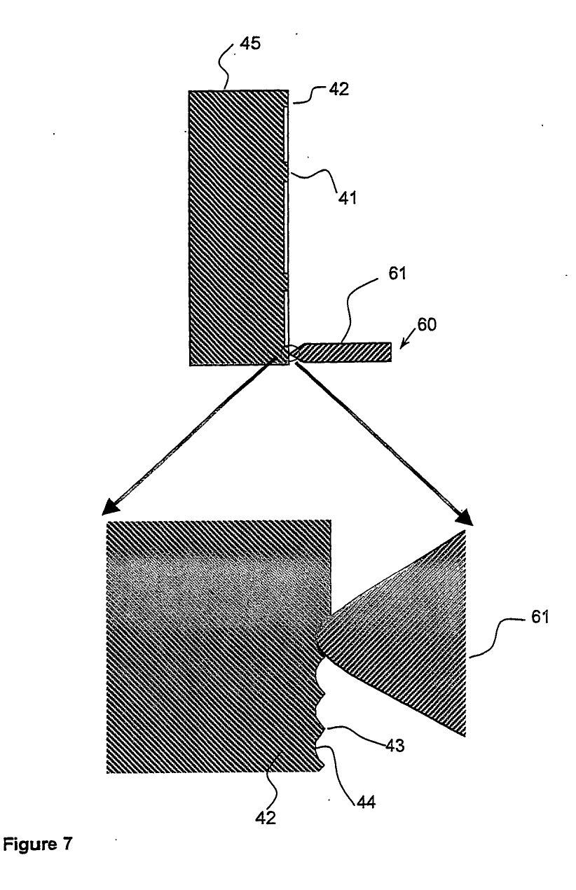

FIG. 7 shows the method of making the final machining operation on the bearing surfaces of the press tool 40. As shown in this Figure, the bearing surfaces 41, 42, 47 of the metal press tool 40 are machined in a conventional metal working lathe 60 so that they are nominally very flat. The point-to point departures from planarity of the bearing surfaces 41, 42, 47 of the press tool 40 depend on the quality of the bearings in the main drive shaft of the lathe 60, and the integrity of the movement of the cross feed that advances the cutting tool in the final machining operation Typically, point-to-point departures from planarity as small as ±0.4 μm are readily achievable with a metal working lathe in good condition.

The final machining operation of the bearing surfaces of the press tool 40 is made in the lathe using a hardened cutting tool 61 that removes an extremely fine layer of the bearing surface of the metal press tool 40. The end of the cutting tool is machined so that its profile reflects the desired shape of the machine surface. In this work, the end of the cutting tool 61 is machined to have a profile that is approximately circular in cross section. In the final machining operation, the cutting tool is advanced at a very slow rate, typically progressing by approximately 25 μm for each turn of the surface being machined. This machining operation therefore leaves a fine spiral structure having a corresponding pitch on the otherwise very flat bearing surface of the metal pressed tool. As shown in FIGS. 7 and 8 this spiral structure consists of a series of ridges 43 that protrude slightly above the nominal plane of these surfaces, separated by hollow grooves 44. As mentioned above, the individual ridges 43 on the bearing surfaces of the metal press tool are typically between 1 μm and 5 μm higher than the groove regions of that surface.

The metal press tool 40 is designed so that it compresses regions of the metal gasket that are centred on the positions of the sealing surfaces (27, 28) of the evacuation head 20, and are slightly wider than the sealing surfaces. This is done so that it will be straight forward to position the evacuation head 20 onto the processed regions of the gasket 10 during the manufacturing process of the glass panel. As an example, a typical evacuation head has lands 27, 28 that are 1 mm wide. In this case, the metal press tool 40 is typically designed so that the bearing surfaces 41, 42 that deform the aluminium gasket are centred in the same positions as the sealing surfaces 27, 28 of the evacuation head and are about 2 mm wide.

The metal press tool 40 illustrated in FIG. 6 is fabricated from a material that is considerably harder than aluminium, such as mild steel or hardened tool steel. The tool comprises two parts 45, 46 that are aligned so that they always come together in the predetermined location when they are used to press a gasket. In one design of the tool as shown, one part 46 is machined so that the bearing surface 47 is uniformly flat, while the bearing surfaces 41,42 on the other part are machined so that they will press upon the aluminium gasket only in regions that correspond in location to the positions of the sealing surfaces of the evacuation head 20. In another design of the press tool, (not shown) the bearing surfaces of both parts are raised relative to the rest of the tool. The principle of operation of the press tool is essentially the same in both cases. As noted above, the sealing surfaces of the press tool are made slightly larger in width with the sealing surfaces of the evacuation head so that the regions of the gasket that are subject to the pressing operation can be located entirely under the sealing surfaces of the evacuation head.

When the evacuation head 20 is being positioned onto the glass panel 101 during the manufacturing process, it is important that the aluminium gasket head 10 is located properly relative to the sealing surface 27, 28 of the head. Specifically, the sealing surfaces of the head must be located entirely on the regions 14, 15 of the gasket that have been deformed in the press tool 40. One relatively simple way of achieving this is to bend parts of the exterior region of the gasket upward whilst it is still held in the press tool 40. This is shown schematically in phantom in FIG. 6. The upwardly bent regions of the pressed gasket provide a guide for positioning the evacuation head 20 in order that the sealing surfaces of the head are appropriately located.

An indication of efficacy of processing an aluminium gasket 1 0 can be obtained by observing the indentation marks left in the gasket by sealing surfaces of the evacuation head following an evacuation operation in which the system is baked to temperatures around 460° C. When a conventionally rolled aluminium gasket is used, the indention marks associated with inelastic deformation of the gasket by sealing surfaces of the evacuation head are discontinuous around the circumference of the sealing areas. For the pressed gasket 10, however, the indentation marks on the gasket following the evacuation operation are observed to be continuous around the circumference of the gasket. This observation indicates that the processing of the gasket enables the sealing surfaces of the evacuation head, and of the outer surface of the glass sheet, to come into much closer contact with the surface of the processed gasket, than occurs for an unprocessed gasket. This, in turn, results in a better vacuum seal, and reduced pressures within the regions of the evacuation head.

The improvements in performance that can be obtained in the evacuation of a flat glass panel using the evacuation head with a processed gasket have been evaluated quantitatively by measuring the conductances associated with the gas flow past the sealing surfaces of the head. In order to perform these measurements, the evacuation head was placed on a glass sheet, and the two regions of the head were evacuated with appropriately designed vacuum systems. The pressures within the two vacuum lines that pumped the separate regions of the cup were recorded while the assembly was heated to temperatures around 460° C., and then cooled. The methods for performing these measurements, and for calculating the conductances for gas flow past the sealing surfaces of the evacuation head, are given in the article entitled “Bakeable, all-metal demountable vacuum seal to a flat glass surface”, by N Ng, R E Collins and M Lenzen, published in the Journal of Vacuum Science and Technology, volume A 20, Number 4, p 13841389, July 2002.

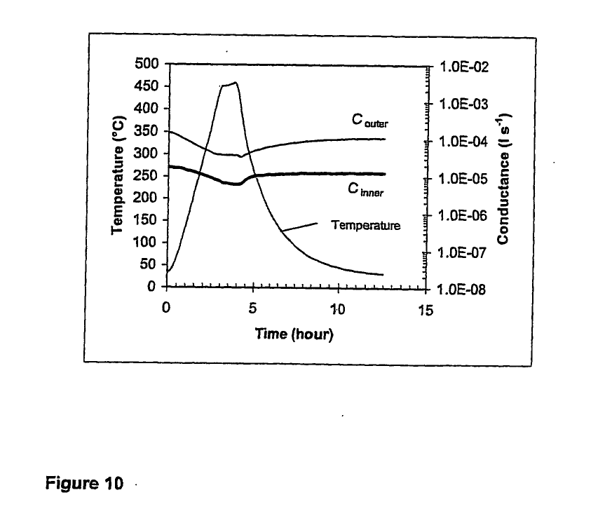

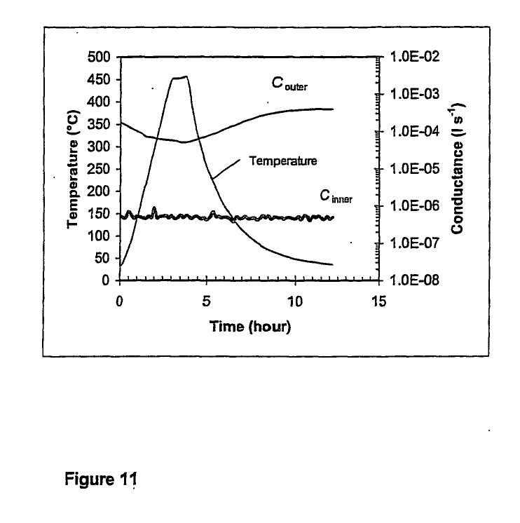

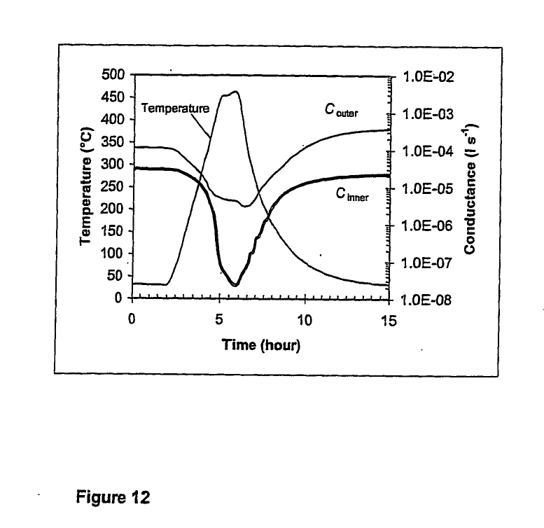

The methods described in this article were used to measure values of the conductance past the outer (Cₒᵤₜ) and inner (Cᵢₙ) sealing surfaces of the evacuation head, when the head was sealed to a 3 mm thick sheet of glass and evacuated. In these measurements, the head and the glass sheet were heated to a temperature of approximately 460° C., held at this temperature for approximately 1 hr, and then allowed to cool. FIG. 10 presents the typical measured conductances, and the temperature, for an evacuation head with no aluminium gasket. FIG. 11 shows similar data when an unprocessed aluminium gasket is used between the head and the glass sheet. In FIG. 12, data are presented when an aluminium gasket is used that has been processed according to the methods described above. In all cases, the measured values of the conductances decrease as the temperature increases. When no aluminium gasket is used (FIG. 10), or for an unprocessed aluminium gasket (FIG. 11), most of this decrease is due to the temperature dependence of the conductances for gas flow past the sealing surfaces and in the evacuation lines. When a processed gasket is used, however, the data in FIG. 12 show that the conductances for gas flow past the sealing surfaces of the evacuation head measured at high temperatures, are substantially less than those which are observed in the absence of a gasket, or when an unprocessed aluminium gasket is used. For example, for an evacuation head with sealing surfaces that are 1 mm wide, the processing of the gasket typically results in a reduction of the conductance at high temperatures for gas flow past the outer sealing surface of an evacuation head from 5×10⁻⁵ 1 s⁻¹ to below 5×10⁻⁶ 1 s⁻¹. Similarly, processing of the gasket typically reduces the conductance at high temperatures associated with gas flow past the inner sealing surface of the evacuation head from 10⁻⁶ 1 s⁻¹ to values close to 10⁻⁸ 1 s⁻¹. These reduced conductances enable the achievement of correspondingly lower pressures within the two separate regions of the evacuation head, and also within the interior of the glass panel, provided that appropriate vacuum pumping technology is used.

The data in FIG. 12 show that the conductances for gas flow past the sealing surfaces of the all-metal cup increase as the temperature of the all-metal cup and glass sheet decreases. The pressure within the panel therefore also increases as the system cools. When the evacuation head 20 with a processed gasket 10 is used to evacuate a vacuum glazing, this normally does not constitute a serious problem, because the glazing is usually sealed when the temperature has decreased to approximately 200° C. At this temperature, the conductances are still very low when a processed aluminium gasket is used between the head and the glass sheet, and the pressure within the glazing is also still correspondingly low. In some applications, however, it may be undesirable for the conductances, and the pressure within the panel, to increase so much as the temperature decreases. This would particularly be the case if it were necessary to cool the panel to room temperature before sealing it. Measurements have shown that, at high temperatures, a relatively weak bond is formed between the aluminium foil and the glass, and that the aluminium gasket does not move relative to the glass sheet during such cooling. The quality of the vacuum seal between these two components is maintained as the system cools to room temperature. It has been shown that the increase in the conductances past the sealing surfaces of the all-metal cup as the system cools is due to the difference in the thermal expansion between the cup and the glass. As the system cools, the evacuation head contracts more than the glass sheet. This causes the sealing surfaces of the cup to move relative to the corresponding regions of the glass. Because the aluminium gasket is bonded to the glass sheet, the cup therefore slides inwards relative to the aluminium gasket. The very good vacuum seal between the cup and the gasket that is formed due to inelastic deformation of the profiled surface of the gasket at high temperatures is therefore degraded as the system cools towards room temperature.

As for most vacuum equipment, the all-metal cup used in the measurements reported in FIGS. 10, 11 and 12 is made from an austenitic (or 300 Series) stainless steel, such as Type 304. This material is readily machined and welded, and retains its strength and corrosion resistance at high temperatures, as required in the vacuum glazing manufacturing process. The coefficient of thermal expansion of this material over the relevant temperature range is approximately 18×10⁻⁶° C.⁻¹. For soda lime glass, the coefficient of thermal expansion is much lower—about 8×10⁻⁶° C.⁻¹.

Materials that are applicable for use in the metal evacuation cup include the martinsitic (or 400 Series) stainless steels. These types of stainless steel have a substantially smaller coefficient of thermal expansion than the austenitic types. For example, the coefficient of thermal expansion of Type 410 stainless steel over the relevant temperature range is approximately 11×10⁻⁶° C.⁻¹. Although these materials are suitable for vacuum equipment, they are seldom applied in this application because the austenitic grades are more convenient to use.

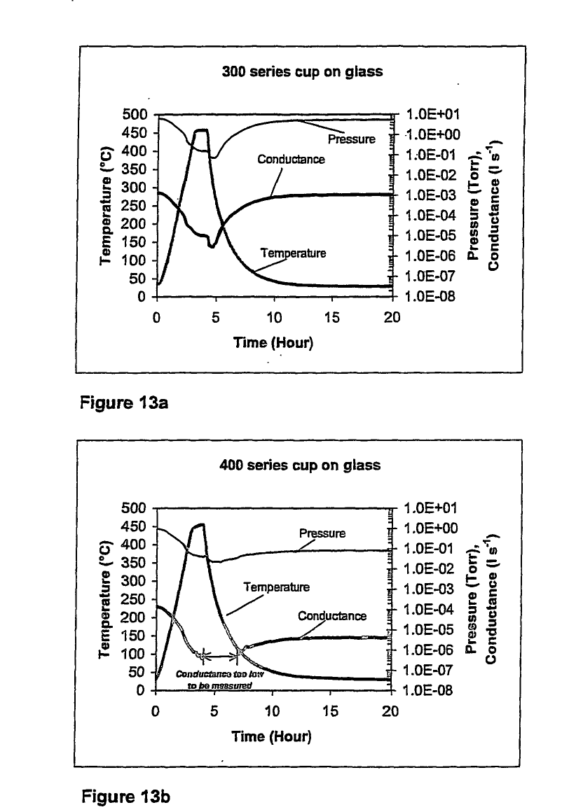

FIG. 13 shows experimental measurements of the pressures in the annular region, and the conductances for gas flow past the outer sealing surfaces, for two evacuation cups that are sealed to a sheet of 3 mm thick glass, and subjected to a high temperature heating cycle. FIG. 13a shows data for an evacuation cup made using a 300 Series (Type 304) stainless steel. FIG. 13b shows corresponding data for an evacuation cup made from a 400 Series (Type 410) stainless steel. These data show that substantially less degradation in the conductance for gas flow past the sealing surface occurs as the temperature decreases for the evacuation cup made from Type 410 stainless steel compared with the data for a cup made from Type 304 stainless steel. The data presented in FIG. 13 show that substantially less degradation occurs in the conductances of the vacuum seals between the all-metal evacuation head and glass sheet when the system cools towards room temperature if there is a much smaller difference in the thermal expansion between the head and the glass.

It is to be appreciated that the benefits of better matching of the expansion characteristics of the evacuation head to the glass wall can be achieved whether the processed gasket 10 is utilised or whether other types of sealing arrangement are provided.

Accordingly, the present invention provides improvements to the sealing of an evacuation head to a glass wall in evacuated glass panel manufacture, that allows significantly higher levels of vacuum to be achieved.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Variations and modifications can be made to the parts previously described without departing from the spirit or ambit of the invention.

1. A gasket for use in providing an air seal between a glass wall and an evacuation head, the gasket having opposite faces and comprising a first sealing surface on one face for engaging a corresponding sealing surface on the evacuation head, and a second sealing surface on the opposite face for engaging the glass wall, wherein the variation in the thickness between the sealing surfaces around the gasket is less than 1 μm.

2. A gasket according to claim 1, wherein the gasket is heat resistant and able to withstand temperatures in excess of 400° C.

3. A gasket according to claim 1, wherein the gasket is formed from a metal or metallic alloy.

4. A gasket according to claim 3, wherein the gasket is formed from aluminium foil having a thickness of between 20 μm and 80 μm.

5. A gasket according to claim 1, wherein the sealing surface on at least one face is profiled so as to be more compliant than a non-profiled surface to deform on applying a compressive force to that sealing face.

6. A gasket according to claim 5, wherein the at least one gasket face is profiled to include an arrangement of at least one raised ridge.

7. A gasket according to claim 6 wherein the or each raised ridge forms the sealing surface of that face of the gasket and extends around the gasket so as to provide a high quality air seal.

8. A gasket according to claim 7, wherein the or each raised ridge extends in a spiral around the sealing face.

9. A gasket according to claim 6, wherein the or each raised ridge is in the form of a ring.

10. A gasket according to claim 5, wherein each sealing surface of the gasket is profiled so as to be more compliant than a non-profiled surface to deform on applying a compressive force to that sealing face.

11. A gasket for use in providing an air seal between a glass wall and an evacuation head, the gasket having opposite faces and comprising a first sealing surface on one face for engaging a corresponding sealing surface on the evacuation head, and a second sealing surface on the opposite face for engaging the glass wall, wherein the sealing surface on at least one face of the gasket is profiled so as to be more compliant than a non-profiled surface to deform on applying a compressive force to that sealing face.

12. A gasket according to claim 11, wherein the at least one gasket face is profiled to include an arrangement of at least one raised ridge.

13. A gasket according to claim 12, wherein the or each raised ridge forms the sealing surface of that face of the gasket and extends around the gasket so as to provide an appropriate air tight seal.

14. A gasket according to claim 13, wherein the or each raised ridge extends in a spiral around the sealing face.

15. A gasket according to either claim 11, wherein the or each raised ridge is in the form of a ring.

16. A gasket according to any one of claim 11, wherein each sealing surface is profiled so as to be more compliant than a non-profiled surface to deform on applying a compressive force to that sealing face.

17. An evacuation head assembly for use in evacuating a chamber that is enclosed at least in part by a glass wall that includes an evacuation port, the assembly comprising an evacuation head having a first cavity that is operative to communicate with the port, and a gasket which extends about said first cavity, the gasket having opposite faces and comprising a first sealing surface on one face for engaging a corresponding sealing surface on the evacuation head, and a second sealing surface on the opposite face for engaging the glass wall, wherein the variation in the thickness between the sealing surfaces around the gasket is less than 1 μm.

18. A method of evacuating a chamber that is enclosed at least in part by a glass wall that includes an evacuation port, the method comprising the steps of:
covering the port and a portion of the glass wall that surrounds the port with an evacuation head having a first cavity that communicates with the port;
providing a gasket between the evacuation head and the glass wall to provide an air seal between the glass wall and the head;
applying a compressive force on the gasket so as to cause it to deform sufficiently to improve the seal between the wall and the head; and
evacuating the glass chamber by way of the first cavity.

19. A method of evacuating a chamber according to claim 18, further comprising the step of subjecting the glass wall to a temperature of greater than 400° C. whilst maintaining the air seal between the glass wall and the evacuation head.

20. A method of evacuating a chamber according to claim 18, wherein the compressive force is applied to the gasket as a result of evacuating a cavity in the evacuation head.

21. A method according to any one of claims 18, wherein the gasket is formed from an aluminium foil having a thickness of between 20 and 80 μm, and wherein on deforming the gasket under the compressive force, the thickness of the gasket measured between the sealing surfaces with the glass wall and the evacuation head reduces by more than 1 μm.

22. A method of evacuating a chamber according to any one of claims 18, further comprising the steps of;
heating the evacuation head, gasket, and glass wall; and
evacuating the chamber during cooling of the evacuation head, gasket and glass wall, wherein the gasket and the evacuation head have a coefficient of thermal expansion that is close to that of the glass wall so as to inhibit relative movement of those components whilst the chamber is being evacuated.

23. An evacuation head for use in evacuating a chamber that is enclosed at least in part by a glass wall that includes an evacuation port, wherein the evacuation head has a coefficient of thermal expansion that is close to that of the glass wall.

24. An evacuation head according to claim 23, wherein the glass wall has a coefficient of thermal expansion of approximately 8×10⁻⁶° C.⁻¹ and the evacuation head is formed from martenistic stainless steel having a coefficient of thermal expansion of approximately 11×10⁻⁶° C.⁻¹.

25. A method of processing a gasket, comprising the steps of;
providing a press tool for pressing the gasket the press tool having opposing faces, at least one of which includes a profiled surface, and
pressing the gasket between the opposing faces of the press tool,
wherein on pressing the gasket, the variation in thickness between the sealing surfaces around the gasket is reduced, and at least one face of the gasket is profiled by the profiled surface so as to be more compliant to deform on applying a compressive force to that sealing face.

26. A gasket according to claim 11, wherein the gasket is heat resistant and able to withstand temperatures in excess of 400° C.

27. A gasket according to claim 11, wherein the gasket is formed from a metal or metallic alloy.

28. A gasket according to claim 11, wherein the gasket is formed from aluminium foil having a thickness of between 20 μm and 80 μm.

29. An evacuation head assembly according to claim 17, wherein the gasket is heat resistant and able to withstand temperatures in excess of 400° C.

30. An evacuation head assembly according to claim 17, wherein the gasket is formed from a metal or metallic alloy.

31. An evacuation head assembly according to claim 17, wherein the gasket is formed from aluminium foil having a thickness of between 20 μm and 80 μm.

32. An evacuation head assembly for use in evacuating a chamber that is enclosed at least in part by a glass wall that includes an evacuation port, the assembly comprising an evacuation head having a first cavity that is operative to communicate with the port, and a gasket which extends about said first cavity, the gasket having opposite faces and comprising a first sealing surface on one face for engaging a corresponding sealing surface on the evacuation head, and a second sealing surface on the opposite face for engaging the glass wall, wherein the sealing surface on at least one face of the gasket is profiled so as to be more compliant than a non-profiled surface to deform on applying a compressive force to that sealing face.

33. An evacuation head assembly according to claim 32, wherein the at least one gasket face is profiled to include an arrangement of at least one raised ridge.

34. An evacuation head assembly according to claim 32, wherein the or each raised ridge forms the sealing surface of that face of the gasket and extends around the gasket so as to provide an appropriate air tight seal.

35. An evacuation head assembly according to claim 32, wherein the or each raised ridge extends in a spiral around the sealing face.

36. An evacuation head assembly according to claim 32, wherein the or each raised ridge is in the form of a ring.

37. An evacuation head assembly according to claim 32, wherein each sealing surface is profiled so as to be more compliant than a non-profiled surface to deform on applying a compressive force to that sealing face.
